(19) United States
(12) Patent Application Publication
(10) Pub. No.: US 2017/0235770 A1
(43) Pub. Date: Aug. 17, 2017

(54) METHOD FOR RESTORING CONTAINERS IN A DATABASE BASED ON PRIORITIES OF THE CONTAINERS

(71) Applicant: International Business Machines Corporation, Armonk, NY (US)

(72) Inventors: Yogesh S. Gawali, Sydney (AU); Prashant N. Kapse, Pune (IN); Kanishka Mandal, Pune (IN)

(21) Appl. No.: 15/045,743

(22) Filed: Feb. 17, 2016

(51) Int. Cl. G06F 17/30

(52) U.S. Cl. CPC G06F 17/30306; G06F 17/30345

(57) ABSTRACT

A method, a computer program product, and a computer system for restoring containers in a database based on priorities of the containers. A computer determines a sequence of restoring respective containers in a database, based on types, counts, and timestamps of activities in the respective containers. The activities include update, delete, insert, and read/select. The computer restores the respective containers, based on the sequence of restoring respective containers in the database.

### BACKGROUND

The present invention relates generally to restoring computer databases, and more particularly to restoring containers in a database based on priorities of the containers.

The today's relational databases need to provide maximum availability to business needs. Ensuring data is always available is a top priority for organizations. Any period of downtime can result in significant loss of revenue and reputation. There are some disastrous situations like storage failures or hardware issues which cause sever corruption in databases; under these situations, databases are required to be restored.

In the era of data warehouses, the large size databases take huge amounts of time for restoring the databases and thus the huge downtimes impact businesses. The database restore must follow certain processes; so far, the restore methods don't have any flexibility to speed up the database restore and cannot prioritize the sequences in order to reduce the downtimes.

At present, containers in a database are restored one by one, according to a list created during taking backup of the database. The list keeps records of the containers according to their creation time. For example, the restore of DB2® (which is a family of database server products developed by IBM®) calls a set of API named db2Restore API. This program reads a container list file and starts restoring the containers according to the list.

### SUMMARY

In one aspect, a method for restoring containers in a database based on priorities of the containers is provided. The method is implemented by a computer. The method includes determining a sequence of restoring respective containers in a database, based on types, counts, and timestamps of activities in the respective containers. The method further includes restoring the respective containers, based on the sequence of restoring respective containers in the database. The activities include update, delete, insert, and read/select.

In another aspect, a computer program product for restoring containers in a database based on priorities of the containers is provided. The computer program product comprises a computer readable storage medium having program code embodied therewith. The program code is executable to: determine a sequence of restoring respective containers in a database, based on types, counts, and timestamps of activities in the respective containers; restore the respective containers, based on the sequence of restoring respective containers in the database. The activities include update, delete, insert, and read/select.

In yet another aspect, a computer system for restoring containers in a database based on priorities of the containers is provided. The computer system comprises one or more processors, one or more computer readable tangible storage devices, and program instructions stored on at least one of the one or more computer readable tangible storage devices for execution by at least one of the one or more processors. The program instructions are executable to determine a sequence of restoring respective containers in a database, based on types, counts, and timestamps of activities in the respective containers. The program instructions are executable to restore the respective containers, based on the sequence of restoring respective containers in the database. The activities include update, delete, insert, and read/select.

### BRIEF DESCRIPTION OF THE SEVERAL VIEWS OF THE DRAWINGS

FIG. 1 is a flowchart showing operating steps for restoring containers in a database based on priorities of the containers, in accordance with one embodiment of the present invention.

FIG. 2 is a diagram illustrating components of a computer device hosting one or more computer programs for restoring containers in a database based on priorities of the containers, in accordance with one embodiment of the present invention.

### DETAILED DESCRIPTION

Currently, the mechanism of restoring a database does not support any priority for containers and the database is only available for business upon the completion of restoring all containers. The current restore mechanism may restore less important containers in a database before more important ones. Since the database is not available till the restoration of all containers, it will directly impact the production during the downtime. The embodiments of the present invention provide a solution for the problem of the current mechanism of restoring a database. In the present invention, a priority list can be provided either by command line, by editing mechanism of a list created during taking backup of the above database, or by tracking usage of containers during different time of a day as business priorities. A container which has a highest priority (most important at that period of time of the day) will be restored and will be made available to business first. The solution disclosed in the present invention helps availability of containers and henceforth the database is available for business within a minimum period of time.

A database administrator may decide the restore priorities of containers of a database. However, the database includes hundreds of containers. It is very difficult for the database administrator to manually determine the priority order. The present invention discloses a computer program; the program determines importance of containers based on their usages on different time of the day.

The core idea of the present invention is to prioritize the containers restore based on the user's input or intelligent algorithm of the program. In the database, there are counters available to determine the inserts, updates and deletes on objects. Furthermore, there are monitoring objects available in the database to track the reads/selects on various objects. These parameters help to identify the most important or containers in the database.

The computer program monitors (i) the types of activities such as insert, update, delete, and select, (ii) the number of times the respective activities are repeated, and (iii) a timestamp of the first occurrence of each activity. The present invention proposes to generate the containers restore sequence by scanning above monitored items and find containers which are more active at some specific timestamps. The computer program stores the historical data and uses it to make the decision later. The computer program decides which container is more important, and decides the containers priority list during different time of the day.

The computer program runs in the background when the database is running. The program maintains a usage history file which has an aggregate of insert, update, and delete across all the objects in the database and further this usage history is mapped with containers. Similarly, the usage history file also contains an aggregate of read/select volumes for containers in the database. The program also maintains an aggregate of usage with timestamps which tells which type of activity is happening and at what time of the day.

The computer program determines a priority list or a restoring sequence of restoring containers on the database, based on a history record including hits of insert, update, and delete. The computer program determines that a container with higher hits of insert, update, and delete has a higher priority. The program restores the container with a higher priority earlier than other container with a lower priority.

The computer program can also set the priorities for containers according to the usage and the time of a day. For example, during business hours, a container with higher hits of insert, update, and delete has a higher priority; however, during off-business hours, a container with higher read/select volumes (instead of higher hits of inserts, updates, and deletes) has a higher priority.

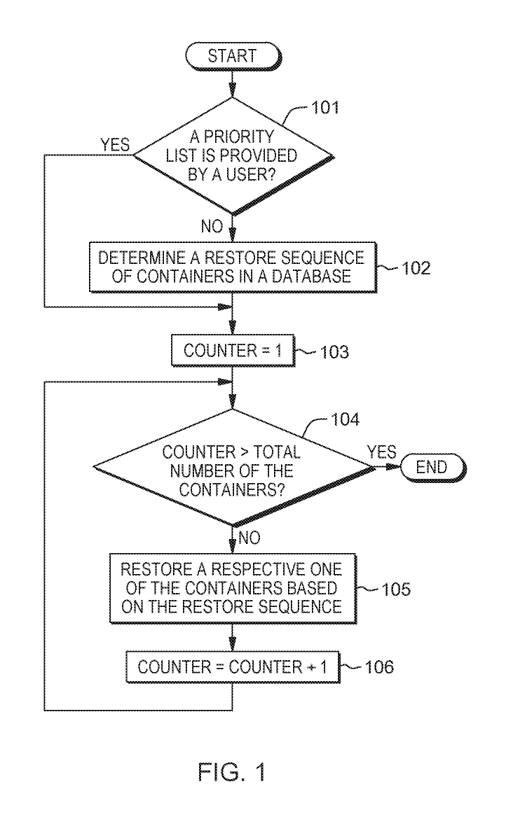

FIG. 1 is a flowchart showing operating steps for restoring containers in a database based on priorities of the containers, in accordance with one embodiment of the present invention. The operating steps are implemented by a computer program. At decision step 101, the computer program determines whether a priority list for restoring containers in the database is provided by a user. The priority list provides a sequence of restoring the containers in the database. A container with a higher priority will be restored earlier than other container with a lower priority.

In response to determining that the priority list for restoring the containers in the database is provided by the user (YES branch of decision step 101), the computer program executes steps 103-106 to restore containers in the database according to the priority list which provides a sequence of restoring the containers in the database.

In response to determining that the priority list for restoring the containers in the database is not provided by the user (NO branch of decision step 101), the computer program at step 102 determines a sequence of restoring the containers in the database. Determining the sequence for restoring the containers in the database is based on a history record including counts of insert, update, and delete across all the objects in the database. Determining the sequence for restoring the containers in the database is also based on a history record including counts of read/select volumes for containers in the database across all the objects in the database. Determining the sequence for restoring the containers in the database is also according to timestamps which tells which type of activity is happening and at what time of the day. In an embodiment, the computer program during business hours determines that a container with higher hits of inserts, updates, and deletes has a higher priority, while the computer program during off-business hours that a container with higher read/select volumes has a higher priority.

At step 103, the computer program set a counter equal to 1. The counter counts the number of the containers which are restored. When restoring the database is started, the counter is set equal to 1. At decision step 104, the computer program determines whether the counter number is greater than the total number of the containers in the database. In response to determining that the counter number is greater than the total number of the containers (YES branch of decision block 104), the computer program ends the execution because all the containers in the database is restored. In response to determining that the counter number is not greater than the total number of the containers (NO branch of decision block 104), the computer program restores a respective one of the containers based on the sequence of restoring the containers. A container which has a higher priority is restored earlier than a container which has a lower priority. After restoring the respective one of the containers, at step 106, the computer program increases the counter number by 1. Then, the computer program reiterates step 104 to restore other containers which have not been restored. After step 105, the respective one of the containers is restored and available for use.

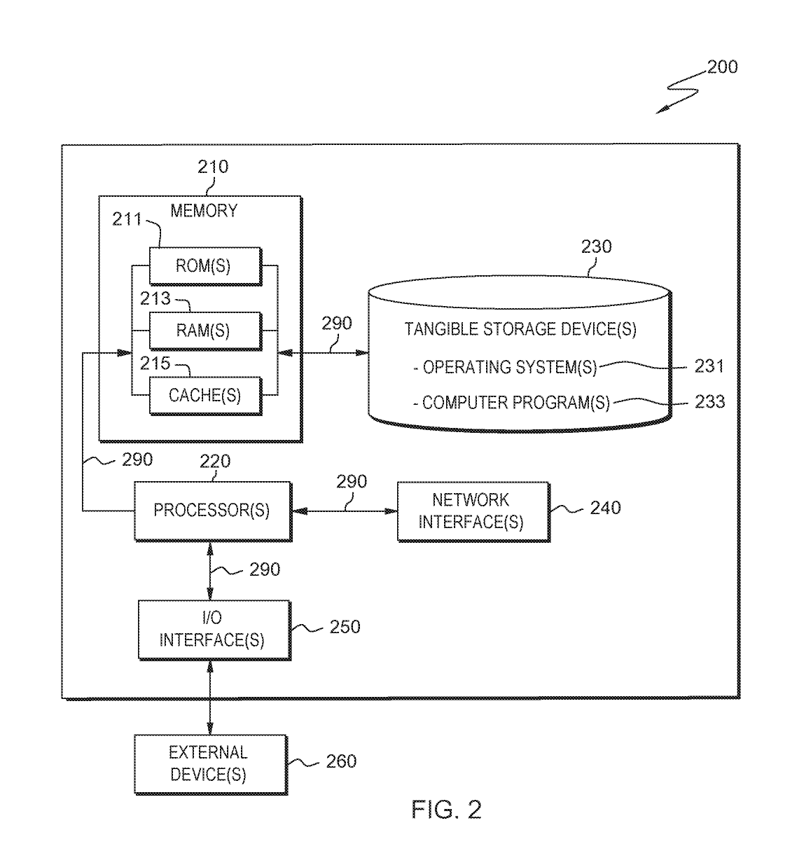

FIG. 2 is a diagram illustrating components of components hosting one or more computer programs for restoring containers in a database based on priorities of the containers, in accordance with one embodiment of the present invention. It should be appreciated that FIG. 2 provides only an illustration of one implementation and does not imply any limitations with regard to the environment in which different embodiments may be implemented.

Referring to FIG. 2, computer device 200 includes processor(s) 220, memory 210, and tangible storage device(s) 230. In FIG. 2, communications among the above-mentioned components of computer device 200 are denoted by numeral 290. Memory 210 includes ROM(s) (Read Only Memory) 211, RAM(s) (Random Access Memory) 213, and cache(s) 215. One or more operating systems 231 and one or more computer programs 233 reside on one or more computer readable tangible storage device(s) 230. One or more computer programs 233 include one or more computer programs for restoring containers in a database based on priorities of the containers. Computer device 200 further includes I/O interface(s) 250. I/O interface(s) 250 allows for input and output of data with external device(s) 260 that may be connected to computer device 200. Computer device 200 further includes network interface(s) 240 for communications between computer device 200 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the “C” programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the FIGs illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for restoring containers in a database based on priorities of the containers, the method comprising:
determining, by a computer, a sequence of restoring respective containers in a database, based on types, counts, and timestamps of activities in the respective containers;
restoring, by the computer, the respective containers, based on the sequence of restoring respective containers in the database; and
wherein the activities include update, delete, insert, and read/select.

2. The method of claim 1, wherein the sequence of restoring the respective containers in the database is determined based on a history record including counts and timestamps of the activities.

3. The method of claim 1, wherein, during business hours, a container that has higher counts of insert, update, and delete has a higher priority to be restored.

4. The method of claim 1, wherein, during off-business hours, a container that has higher read/select volumes has a higher priority to be restored.

5. The method of claim 1, further comprising:
determining, by the computer, whether a priority list is provided by a user, the priority list including the sequence of restoring the respective containers in the database; and
in response to determining that priority list is provided by the user, restoring by the computer the respective containers according to the priority list.

6. A computer program product for restoring containers in a database based on priorities of the containers, the computer program product comprising a computer readable storage medium having program code embodied therewith, the program code executable to:
determine a sequence of restoring respective containers in a database, based on types, counts, and timestamps of activities in the respective containers;
restore the respective containers, based on the sequence of restoring respective containers in the database; and
wherein the activities include update, delete, insert, and read/select.

7. The computer program product of claim 6, wherein the sequence of restoring the respective containers in the database is determined based on a history record including counts and timestamps of the activities.

8. The computer program product of claim 6, wherein, during business hours, a container that has higher counts of insert, update, and delete has a higher priority to be restored.

9. The computer program product of claim 6, wherein, during off-business hours, a container that has higher read/select volumes has a higher priority to be restored.

10. The computer program product of claim 6, further comprising the program code executable to:
determine whether a priority list is provided by a user, the priority list including the sequence of restoring the respective containers in the database; and
in response to determining that priority list is provided by the user, restore the respective containers according to the priority list.

11. A computer system for restoring containers in a database based on priorities of the containers, the computer system comprising:
one or more processors, one or more computer readable tangible storage devices, and program instructions stored on at least one of the one or more computer readable tangible storage devices for execution by at least one of the one or more processors, the program instructions executable to:
determine a sequence of restoring respective containers in the database, based on types, counts, and timestamps of activities in the respective containers;
restore the respective containers, based on the sequence of restoring respective containers in a database; and
wherein the activities include update, delete, insert, and read/select.

12. The computer system of claim 11, wherein the sequence of restoring the respective containers in the database is determined based on a history record including counts and timestamps of the activities.

13. The computer system of claim 11, wherein, during business hours, a container that has higher counts of insert, update, and delete has a higher priority to be restored.

14. The computer system of claim 11, wherein, during off-business hours, a container that has higher read/select volumes has a higher priority to be restored.

15. The computer system of claim 11, further comprising the program instructions executable to:
determine whether a priority list is provided by a user, the priority list including the sequence of restoring the respective containers in the database; and
in response to determining that priority list is provided by the user, restore the respective containers according to the priority list.
